(19) United States
(12) Patent Application Publication
(10) Pub. No.: US 2025/0174386 A1
(43) Pub. Date: May 29, 2025

(54) TRANSFORMER COMPONENT

(71) Applicant: TDK CORPORATION, Tokyo (JP)

(72) Inventors: Hitoshi OHKUBO, Tokyo (JP); Hokuto Eda, Tokyo (JP); Masazumi Arata, Tokyo (JP); Kohei Takahashi, Tokyo (JP); Hiroki Asafusa, Tokyo (JP); Takahiro Nemoto, Tokyo (JP)

(73) Assignee: TDK CORPORATION, Tokyo (JP)

(21) Appl. No.: 18/888,772

(22) Filed: Sep. 18, 2024

(30) Foreign Application Priority Data
Nov. 27, 2023 (JP) 2023-199832

(51) Int. Cl. H01F 27/00

(52) U.S. Cl. CPC H01F 27/006

(57) ABSTRACT

In the transformer component, the inner diameter area of the primary winding is designed to be relatively large, and is larger than the inner diameter area of the secondary winding. Therefore, flux saturation is less likely to occur in the inner diameter region of the primary winding L1, and a low-loss transformer component is obtained. The inner diameter area of the secondary winding is designed to be relatively small, whereby the width of the spiral conductor constituting the secondary winding is sufficiently secured to achieve resistance reduction.

### CROSS-REFERENCE TO RELATED APPLICATIONS

This application is based upon and claims the benefit of priority from Japanese Patent Application No. 2023-199832, filed on 27 Nov. 2023, the entire content of which is incorporated herein by reference.

### TECHNICAL FIELD

The present disclosure relates to a transformer component.

### BACKGROUND

Japanese Unexamined Patent Application Publication No. 2012-89760 discloses a transformer component in which a primary winding and a secondary winding are provided in an element body.

### SUMMARY

The inventors have studied the loss of the transformer component, and have newly found a technique capable of reducing the loss by reducing the flux saturation.

According to one aspect of the present disclosure, a transformer component achieving loss reduction is provided.

A transformer component according to one aspect of the present disclosure includes an element body, a primary winding provided in the element body and wound around a coil axis along a first direction, a secondary winding formed on a substrate orthogonal to the first direction in the element body, overlapping the primary winding in the first direction, and wound around the coil axis to have a magnetic circuit common to the primary winding. A number of turns of the primary winding is greater than a number of turns of the secondary winding, and an inner diameter area of the primary winding is greater than an inner diameter area of the secondary winding.

In the transformer component described above, the inner diameter area of the primary winding having a larger number of turns than the secondary winding is larger than the inner diameter area of the secondary winding, whereby flux saturation is reduced to reduce loss of the transformer component.

### BRIEF DESCRIPTION OF THE DRAWINGS

FIG. 1 is a schematic exploded perspective view showing a transformer component according to one embodiment.

FIG. 2 is a schematic cross-sectional view of the transformer component shown in FIG. 1.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

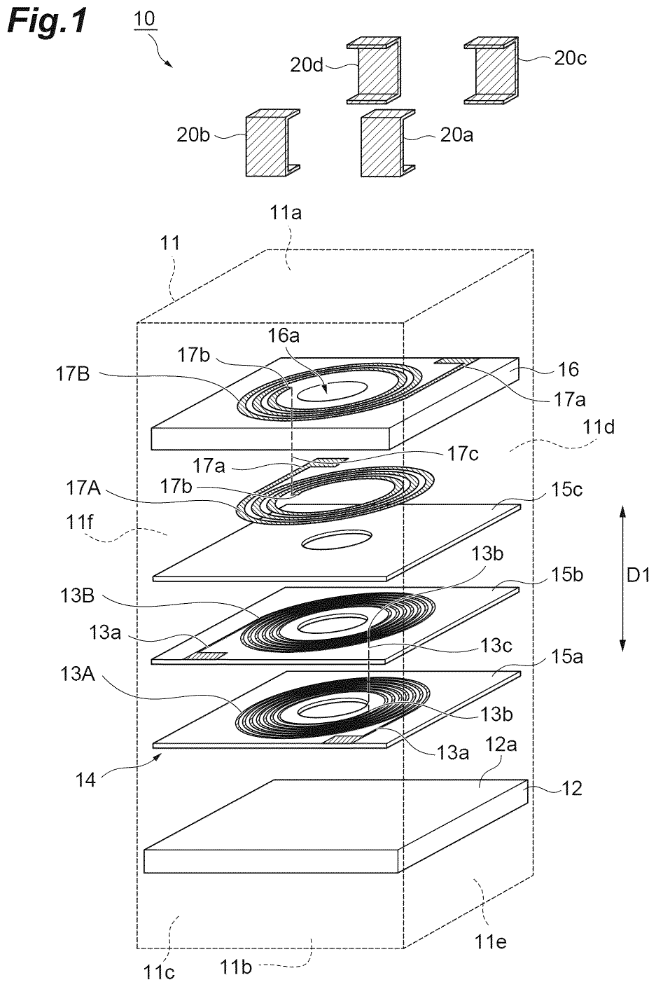

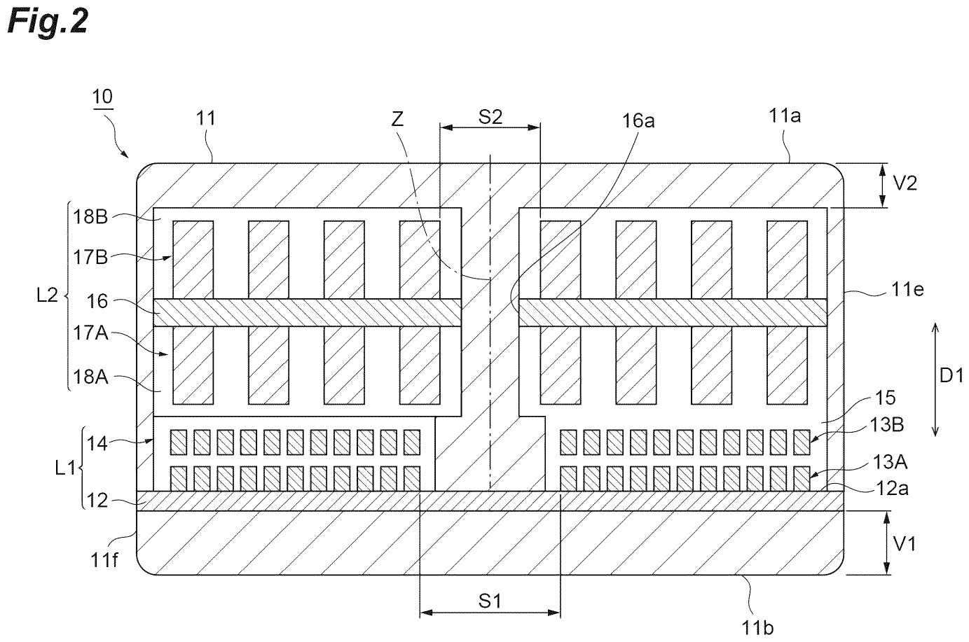

As shown in FIGS. 1 and 2, a transformer component 10 according to one embodiment is configured to include a primary winding L1 and a secondary winding L2 in an element body 11. Specifically, the transformer component 10 is configured with a ferrite substrate 12, a thin film coil layer 14 including a first spiral conductor 13A and a second spiral conductor 13B formed on the ferrite substrate 12, a printed substrate 16 provided over the ferrite substrate 12, a third spiral conductors 17A and a fourth spiral conductor 17B formed on both surfaces of the printed substrate 16, and four terminal electrodes 20a to 20d. In the present embodiment, the primary winding L1 includes the ferrite substrate 12 and the thin film coil layer 14 and the secondary winding L2 includes the printed substrate 16 and the third spiral conductors 17A and the fourth spiral conductor 17B.

The element body 11 has an outer shape of a rectangular flat plate, and has four side surfaces 11c to 11f connecting a pair of main surfaces 11a and 11b opposing in a first direction D1. The ferrite substrate 12, the thin film coil layer 14, the printed substrate 16, the third spiral conductor 17A and the fourth spiral conductor 17B are embedded in the element body 11. The terminal electrodes 20a to 20d are provided respectively on the side surfaces 11c to 11f of the element body 11. In the present embodiment, of the side surfaces 11c and 11d opposing each other, the side surface 11c is provided with the pair of terminal electrodes 20a and 20b, and the side surface 11d is provided with the pair of terminal electrodes 20c and 20d.

The element body 11 is configured with magnetic material. In the present embodiment, the element body 11 is configured with metal magnetic powder-containing resin. In the case of using the metal magnetic powder-containing resin, there exist small gaps between metal magnetic powder and resin, which increase the saturation magnetic flux density, hence, it is possible to omit gaps between elements embedded in the element body 11. The metal magnetic powder-containing resin is magnetic material in which a metal magnetic powder is mixed into resin. A permalloy-based material can be used as the metal magnetic powder. Specifically, a metal magnetic powder containing a Pb—Ni—Co alloy having an average particle diameter of 20 to 50 μm as a first metal magnetic powder and a carbonyl iron having an average particle diameter of 3 to 10 μm as a second metal magnetic powder at a predetermined ratio, for example, 70:30 to 80:20, or a weight ratio of 75:25 may be used. The content of the metal magnetic powder may be 90 to 96 wt. %.

When the amount of the metal magnetic powder is decreased with respect to the resin, the saturation magnetic flux density is decreased, and conversely, when the amount of the metal magnetic powder is increased, the saturation magnetic flux density is increased. Therefore, the saturation magnetic flux density may be adjusted only by the amount of the metal magnetic powder. Further, the metal magnetic powder may be obtained by mixing the first metal magnetic powder having an average particle diameter of 5 μm and the second metal magnetic powder having an average particle diameter of 50 μm at a predetermined ratio, for example, 75:25. When two kinds of metal magnetic powders having different particle diameters are used, a magnetic core having high density can be made under low pressure or non-pressure situation, and the magnetic core having high magnetic permeability and low loss can be obtained. The resin contained in the metal magnetic powder-containing resin functions as an insulating binder. A liquid epoxy resin or a powder epoxy resin can be used as a material of the resin. Further, the content of the resin may be 4 to 10 wt. %.

The ferrite substrate 12 is a rectangular flat plate extending orthogonally to the first direction D1 and constitutes a portion of the closed magnetic circuit. Although not particularly limited, the planar dimension of the ferrite substrate 12 can be, for example, about 3.2 mm*2.5 mm. Sintered ferrite can be used as a material of the ferrite substrate 12, or a material having high magnetic permeability such as a Ni—Cu—Zn-based ferrite, a Mn—Zn-based ferrite can be used. By using such a magnetic material, the magnetic properties of the transformer can be enhanced.

The thin film coil layer 14 is formed on one of main surfaces (upper surface) 12a of the ferrite substrate 12. The thin film coil layer 14 is obtained by laminating a first insulating layer 15a, the first spiral conductor 13A, a second insulating layer 15b, the second spiral conductor 13B, and a third insulating layer 15c in this order.

The first spiral conductor 13A is formed on the surface of the first insulating layer 15a formed on the ferrite substrate 12. This is to smooth the unevenness of the surface of the ferrite substrate 12 to obtain the flat surface, and enable the formation of a fine pattern. However, if the flatness of the ferrite substrate 12 is sufficient, the first insulating layer 15a may be omitted, and in this case, the first spiral conductor 13A may be formed directly on the ferrite substrate 12.

The first insulating layer 15a, the second insulating layer 15b, and the third insulating layer 15c can be formed by spin coating and subjecting to exposure, development, and thermal curing of insulating non-magnetic resin having photosensitivity (for example, a photosensitive polyimide resin).

Each of the first spiral conductor 13A and the second spiral conductor 13B is circular spiral. The first spiral conductor 13A and the second spiral conductor 13B are wound around a coil axis Z parallel to the first direction D1. The first spiral conductor 13A and the second spiral conductor 13B overlap generally but they do not overlap completely in the plan view.

That is, when viewed from above, the first spiral conductor 13A configures a counterclockwise spiral from an outer turn end 13a to an inner turn end 13b, and the second spiral conductor 13B configures a counterclockwise spiral from an inner turn end 13b to an outer turn end 13a. As a result, the directions of the magnetic fluxes generated by current flowing through the spiral conductors 13A and 13B are same. For example, the magnetic flux along the coil axis Z is generated in the inner diameter regions of the spiral conductors 13A and 13B. Since magnetic fluxes generated in the spiral conductors 13A and 13B are superposed and strengthened, a large inductance can be obtained.

The outer turn ends 13a of the first spiral conductor 13A and the second spiral conductor 13B are extracted to the side surfaces of the ferrite substrate 12 or the first insulating layer 15a to be connected to the pair of the terminal electrodes 20a and 20b, respectively. The inner turn ends 13b of the first spiral conductor 13A and the second spiral conductor 13B are connected to each other via a contact hole conductor 13c penetrating the second insulating layer 15b. As a result, the first spiral conductor 13A and the second spiral conductor 13B configure a single coil (i.e., the primary winding) series-connected to each other.

The first spiral conductor 13A and the second spiral conductor 13B are formed by the fine wiring process. Specifically, a Cu film or a multilayer film (Cr/Cu film) in which a Cu film and a Cr film are laminated in order is formed as an underlying conductive film by sputtering or vapor deposition, and a photoresist film is formed by a spin coating method. Subsequently, a negative pattern of the spiral conductors is formed by exposing and developing the photoresist film, and the underlying conductive film is selectively plated and grown using the mask pattern, thereby forming the spiral conductors.

Similarly to the ferrite substrate 12, the printed substrate 16 extends orthogonally to the first direction D1. The printed substrate 16 is superposed on one side (upper side) of the ferrite substrate 12 with respect to the first direction D1. The printed substrate 16 is a support substrate for providing a forming surface for the third spiral conductor 17A and the fourth spiral conductor 17B. The printed substrate 16 has a circular aperture 16a in its central portion. The aperture 16a of the printed substrate 16 is formed in the region corresponding to the coil axis Z. The thickness of the printed substrate 16 can be, for example, about 0.06 mm. The material of the printed substrate 16 may be a general printed substrate material obtained by impregnating a glass cloth with an epoxy resin, for example, a B-T substrate, a FR4 substrate, a FR5 substrate, or the like may be used. Further, a ceramic substrate may be used as the material for the printed substrate. When these materials for the printed substrate are used, the spiral conductors can be formed not by sputtering in a thin film method but by plating, the thicknesses of the spiral conductors can be made sufficiently thick. In order to avoid increase of the stray capacitance, the dielectric constant of the printed substrate 16 may be not more than 7 (μ≤7).

Each of the third spiral conductor 17A and the fourth spiral conductor 17B is also circular spiral. The third spiral conductor 17A and the fourth spiral conductor 17B are wound around the coil axis Z parallel to the first direction D1. The third spiral conductor 17A and the fourth spiral conductor 17B are arranged to surround the aperture 16a of the printed substrate 16.

The third spiral conductor 17A and the fourth spiral conductor 17B overlap generally but they do not overlap completely in the plan view.

That is, when viewed from above, the third spiral conductor 17A configures a clockwise spiral from an outer turn end 17a to an inner turn end 17b, and the fourth spiral conductor 17B upper configures a clockwise spiral from an inner turn end 17b to an outer turn end 17a.

As a result, the directions of the magnetic fluxes generated by current flowing through the spiral conductors 17A and 17B are same. For example, a magnetic flux along the coil axis Z parallel to the first direction D1 is generated in the inner diameter regions of the spiral conductors 17A and 17B. Since magnetic fluxes generated in the spiral conductors 17A and 17B are superposed and strengthened, a large inductance can be obtained.

The outer turn ends 17a of the third spiral conductor 17A and the fourth spiral conductor 17B are extracted to the side surfaces of the printed substrate 16 to be connected to the pair of the terminal electrodes 20c and 20d, respectively. The inner turn ends 17b of the third spiral conductor 17A and the fourth spiral conductor 17B are connected to each other via a through-hole conductor 17c penetrating the printed substrate 16. As a result, the third spiral conductor 17A and the fourth spiral conductor 17B configure a single coil (i.e., the secondary winding) series-connected to each other.

In a present embodiment, the primary winding L1 and the secondary winding L2 overlap in the first direction D1 and have a common magnetic circuit. The formation regions of the first spiral conductor 13A and the second spiral conductor 13B constituting the primary winding L1 and the formation regions of the third spiral conductor 17A and the fourth spiral conductor 17B constituting the secondary winding L2 overlap substantially in the plan view. The formation region refers to an occupied region of a planar coil configured by spiral conductors. Due to the configuration in which the formation regions of the primary winding L1 and the secondary winding L2 overlap each other, the magnetic flux generated by the primary winding L1 and the magnetic flux generated by the secondary winding L2 are superposed and strengthened, and thus a large mutual inductance may be obtained. Therefore, magnetic coupling between the primary winding L1 and the secondary winding L2 may be strengthened, and a transformer component having high conversion efficiency may be provided.

Both ends of the primary winding L1 including the first spiral conductor 13A and the second spiral conductor 13B are connected to the pair of the terminal electrodes 20a and 20b, respectively, and both ends of the secondary winding L2 including the third spiral conductor 17A and the fourth spiral conductor 17B are connected to the pair of the terminal electrodes 20c and 20d, respectively. The first spiral conductor 13A and the second spiral conductor 13B may be a fine pattern with a narrow pitch, and the conductor width may be 2 to 10 μm. According to this configuration, the primary winding L1 including the first spiral conductor 13A and the second spiral conductor 13B is used as a secondary coil of the step-up transformer.

Since the thin film coil layer 14 including the spiral conductors 13A and 13B is formed by a thin film method, spiral conductors having a large number of turns can be formed with a very narrow pitch. The third spiral conductor 17A and the fourth spiral conductor 17B are thick film patterns wider than the first spiral conductor 13A and the second spiral conductor 13B, and for example. In the third spiral conductor 17A and the fourth spiral conductor 17B, the conductor width may be 20 to 100 μm, and the conductor thickness may be 25 to 150 μm. According to this configuration, the secondary winding L2 including the third spiral conductor 17A and the fourth spiral conductor 17B is used as a primary coil of the step-up transformer. Although not particularly limited, the turn ratio between the primary coil and the secondary coil may be 1:2 to 1:20.

Since the third spiral conductor 17A and the fourth spiral conductor 17B are formed on the surfaces of the printed substrate 16, they can be formed by a semi-additive method.

In the transformer component 10 according to the present embodiment, the number of turns of the primary winding L1 is designed to be greater than the number of turns of the secondary winding L2. In this case, the magnetic flux density of the primary winding L1 may be higher than the magnetic flux density of the secondary winding L2.

In the transformer component 10, an inner diameter area S1 of the primary winding L1 is designed to be relatively large, which is larger than an inner diameter area S2 of the secondary winding L2. As a result, flux saturation is less likely to occur in the inner diameter region of the primary winding L1, and a low-loss transformer component is obtained. The inner diameter area S2 of the secondary winding L2 is designed to be relatively small, whereby the width of the spiral conductors 17A and 17B constituting the secondary winding L2 is sufficiently secured to achieve resistance reduction.

Further, the transformer component 10 is designed such that the volume V1 of the magnetic material constituting the main surface 11b on the primary winding L1 side is larger than the volume V2 of the magnetic material constituting the main surface 11a on the secondary winding L2 side with respect to the first direction D1. In other words, the thickness of the magnetic material between the primary winding L1 and the main surface 11b is thicker than the thickness of the magnetic material between the secondary winding L2 and the main surface 11a. As a result, magnetic flux saturation and magnetic flux leakage are less likely to occur in the main surface 11b on the primary coil L1 side.

Furthermore, the opposing distance between the primary winding L1 and the secondary winding L2 is very close. In the present embodiment, the insulating layer 15c is only interposed between the second spiral conductor 13B and the third spiral conductor 17A. Therefore, magnetic coupling between the primary winding L1 and the secondary winding L2 may be further strengthened, and a transformer having high conversion efficiency may be implemented.

The third spiral conductor 17A and the fourth spiral conductor 17B can be formed by forming an underlying conductive film (for example, a Cu film) by electroless plating, pasting a photoresist sheet, forming a negative pattern of spiral conductors by exposing and developing the photoresist sheet, and plating selectively and growing the underlying conductive film by using the mask pattern.

Since the thicknesses of the third spiral conductor 17A and the fourth spiral conductor 17B formed in this way is sufficiently thicker than the first spiral conductor 13A and the second spiral conductor 13B, the DC resistance can be sufficiently reduced.

The present invention is not limited to the above embodiments and may be variously modified. For example, the coil is not limited to an annular coil, and may be an elliptical annular coil, a rectangular annular 10 coil, or the like. Further, the number of the turns of the coil may be increased or decreased appropriately.

What is claimed is:

1. A transformer component comprising:
an element body;
a primary winding provided in the element body and wound around a coil axis along a first direction;
a secondary winding formed on a substrate orthogonal to the first direction in the element body, overlapping the primary winding in the first direction, and wound around the coil axis to have a magnetic circuit common to the primary winding,
wherein a number of turns of the primary winding is greater than a number of turns of the secondary winding, and an inner diameter area of the primary winding is greater than an inner diameter area of the secondary winding.

2. The transformer component according to claim 1, wherein the primary winding is formed on a magnetic substrate.

3. The transformer component according to claim 1, wherein the element body is configured with a magnetic material, a volume of the magnetic material constituting a surface of the element body on the primary winding side with respect to the first direction, is larger than a volume of the magnetic material constituting a surface of the element body on the secondary winding side with respect to the first direction.
